(19) United States
(12) Patent Application Publication
(10) Pub. No.: US 2005/0183924 A1
(43) Pub. Date: Aug. 25, 2005

(54) Driving apparatus for a movable member of an automobile

(75) Inventors: Ryoichi Fukumoto, Nagoya-shi (JP); Tomoaki Nishimura, Kariya-shi (JP); Hiroki Okada, Okazaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Aisin Seiki Kabushiki Kaisha

(21) Appl. No.: 11/061,530

(22) Filed: Feb. 22, 2005

(30) Foreign Application Priority Data
Feb. 23, 2004 (JP) 2004-046471

(51) Int. Cl. F16D 27/00

(52) U.S. Cl. 192/84.961

(57) ABSTRACT

A driving apparatus for a movable member of an automobile comprises a housing, a dram for driving the movable member, the dram being rotatably supported on the housing, and a clutch for selectively transmitting a driving torque to the dram, wherein the clutch is accommodated in a space of the dram.

### CROSS REFERENCE TO RELATED APPLICATIONS

This application is based on and claims priority under 35 U.S.C. §119 with respect to Japanese Patent Application No. 2004-046471 filed on Feb. 23, 2004, the entire content of which is incorporated herein by reference.

### FIELD OF THE INVENTION

The present invention relates to a driving apparatus for a movable member of an automobile.

### BACKGROUND

According to JP2002-327576A, an apparatus automatically drives (opens and closes) a slide door for a side opening of an automobile. The apparatus comprises a housing, an output dram rotatably supported on the housing through a rotatable shaft, a motor for generating a driving torque and a clutch for selectively transmitting the driving torque from the motor to the output dram. A reduction mechanism is interposed between the output dram and the motor. A cable is installed between the output dram and an input dram connected to the slide door so that the driving torque is transmitted from the output dram to the slide door. The output dram, the reduction mechanism and the clutch are coaxially installed on the shaft. The apparatus is complicated in construction so that minitualization thereof is restricted.

### SUMMARY OF THE INVENTION

In light of the foregoing, the present invention provides a driving apparatus for a movable member of an automobile comprising a housing, a dram for driving the movable member, the dram being rotatably supported on the housing, and a clutch for selectively transmitting a driving torque to the dram, wherein the clutch is accommodated in a space of the dram.

### BRIEF DESCRIPTION OF THE DRAWINGS

The foregoing and additional features and characteristics of the present invention will become more apparent from the following detailed description when considered with reference to the accompanying drawings, wherein:

FIG. 1 is a constructive view of a driving apparatus for a movable member of an automobile according to the invention;

FIG. 2 is an upper view of the driving apparatus of FIG. 1;

FIG. 3 is a cross-sectional view of a driving apparatus according to a first embodiment of the invention;

FIG. 4 is a cross-sectional view of a driving apparatus according to a first embodiment of the invention; and

FIG. 5 is a cross-sectional view of a driving apparatus according to a first embodiment of the invention.

### DETAILED DESCRIPTION

Embodiments of the present invention will be explained with reference to illustrations of the drawing figures as follows.

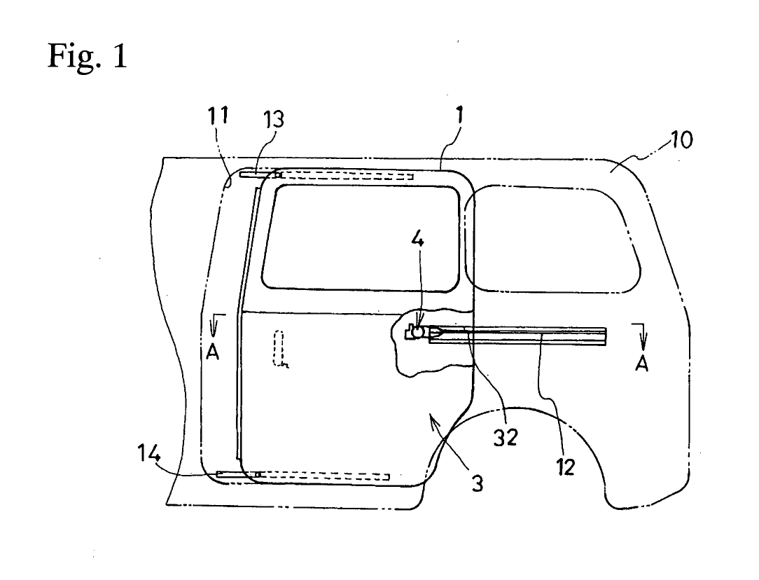

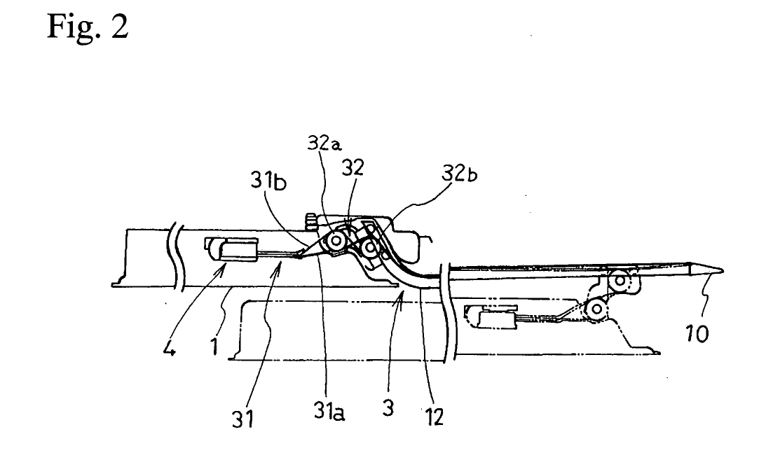

As shown in FIGS. 1 and 2, an automobile 100 is equipped with a slide door (a movable member) 1 for opening and closing a side opening 11 of the automobile so that a passenger rides in and gets out the automobile. The side opening 11 is formed on a side body 10 of the automobile. A center guide rail 12 and a pair of upper as well as lower guide rails 13 and 14 are fixed to the side body 10 in front and rearward direction of the automobile. The slide door 1 is slidably supported on the side body 10 through the rails 12, 13 and 14.

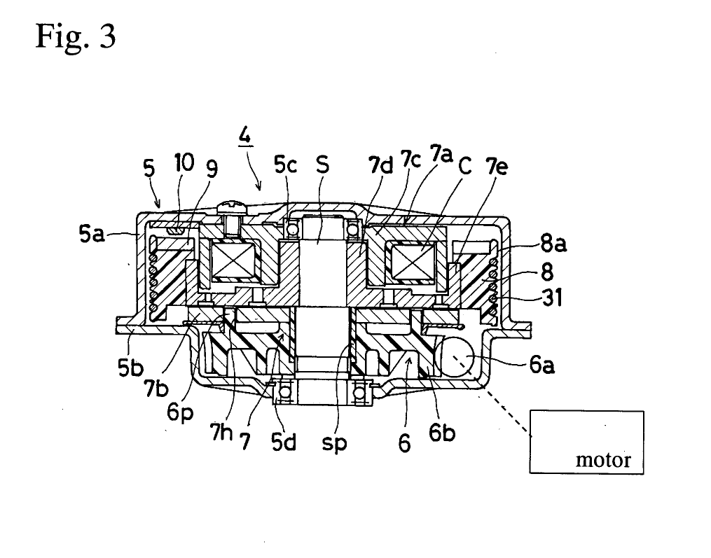

Referring to FIG. 3, a first embodiment is explained hereinafter. A driving apparatus 4 is installed in the slide door 1 and a cable 31 comprises wires 31a and 31b that is wound on and/or out the driving apparatus 4. A pair of pulleys 32 (32a and 32b) is installed so that the slide door 1 slides along the center guide rail 12. Each of the wires 31a and 31b is fixed to an output dram 8 (FIG. 3) of the driving apparatus 4 at one end and wound on the dram while each of the wires 31a and 31b is fixed near of front end of the center guide rail to the side body 10 at the other end. The wires 31a and 31b are guided by the pulleys 31a and 32b so as to be passed through the center guide rail 12.

The driving apparatus 4 comprises a housing 5, a reduction mechanism 6, a clutch 7 and an output dram 8. The housing 5 comprises a cover 5a and a base 5b and the cover 5a is fixed to the base by a connecting member (not shown). The reduction mechanism 6, the clutch 7 and the output dram 8 are accommodated in a space of the housing 5. Bearings 5c and 5d are fixed to the cover 5a and the base 5b, respectively, so that a rotational shaft S is supported on the housing S therethrough.

The well-known reduction mechanism 6 comprises a worm gear 6a fixed to an output shaft of a motor (not shown) and a disk-shaped worm wheel gear (input member) 6b that is geared with the worm gear 6a. The worm wheel gear 6b is rotatably supported on the shaft S through a cylindrical spacer sp. The spacer sp is fixed to the gear 6b so that the gear 6b and the spacer sp uniformly rotate.

The clutch 7 comprises a solenoid mechanism 7a and an armature 7b. The solenoid mechanism 7a comprises a cylindrical-shaped core 7c for holding a coil C wound on a bobbin as well as a disk-shaped rotor 7d facing to the armature 7b and the core 7c in axial direction. The core 7c made of a magnetic material is fixed to the cover Sa of the housing 5. The rotor 7d made of a magnetic material is fixed to the shaft S so as to integrally rotate. The output dram 8 is fixed to an outer circumference 7e of the rotor 7d.

The disk-shaped armature 7b made of magnetic material is located between the worm wheel gear 6b and the rotor 7d so that upper and lower planes of the armature 7b face an upper side of the worm wheel gear 6b and a lower plane of the rotor 7d, respectively. The armature 7b is rotatably and movably, in axial direction, supported on the spacer sp so that the armature 7b is rotatably and movably, in axial direction, supported on the shaft S through the spacer sp. A plurality of holes 7h are provided in the armature 7b so that a plurality of projections 6p of the worm wheel gear 6b is inserted into the holes 7h, respectively. The worm wheel gear 6b and the armature 7b are connected each other through the projections 6p and the holes 7h. The armature 7b integrally rotates with the worm wheel gear 6b so that a driving torque of the motor is transmitted to the armature 7b through the reduction mechanism 6.

While the coil C is energized, a magnetic flux is generated through the coil C, the armature 7b, the core 7c and the rotor 7d so that armature 7b is adsorbed on the rotor 7d. Namely, the armature 7b moves to the rotor 7d on the spacer sp in axial direction and the armature 7b is frictionally engaged with the rotor 7d. Here, the driving torque of the motor is transmitted to the rotor 7d through the reduction mechanism 6 and the armature 7b. While the coil C is not energized, no magnetic flux is generated through the coil C, the armature 7b, the core 7c and the rotor 7d so that armature 7b is apart from the rotor 7d. Namely, no frictional engagement between the armature 7b and the rotor 7d is established. Here, the driving torque of the motor is not transmitted to the rotor 7d.

The output dram 8 made of resin is cylindrically shaped. The output dram 8 is fixed on an outer portion 7e of the rotor 7d so that the rotor 7d and the output dram 8 are integrally rotate. The armature 7b, the core 7c and the rotor 7d are located near by the output dram 8. Namely, most portion of the clutch 7 is accommodated in the inner space of the cylindrical-shaped output dram 8. Namely a dead-volume space of the output dram 8 is occupied by the clutch 7 so that space is sufficiently used in axial direction of the shaft S. A ring-shaped magnet 9 is fixed on the upper face of the output dram 8 so that N- and S-poles of the magnet 9 are alternatively arranged. Revolution number and direction are detected by the magnet 9 in cooperation with a hole IC 9.

The coil C of the solenoid mechanism 7a is energized so that the armature 7b and the rotor 7d are frictionally engaged each other. The driving torque of the motor is transmitted to the rotor 7d since the torque passes through the reduction mechanism 6 and the armature 7b. That is, the armature 7b and the rotor 7d integrally rotate each other so that the output dram 8 also rotates with the rotor 7d integrally. One of the wires 31a and 31b is wound on the output dram 8 and the other of them is wound out the output dram 8 so that the slide door 1 moves in open/close direction.

The coil C of the solenoid mechanism 7a is not energized so that the armature 7b and the rotor 7d are not engaged each other. The slide door 1 is, therefore, manually operated and the output dram 8 rotates in accordance with the movement of the slide door 1 through the wires 31a and 31b. The rotation of the output dram 8 is not transmitted to the armature 7b and the clutch 6. Namely, smooth and/or easy manually operation of the slide door is achieved.

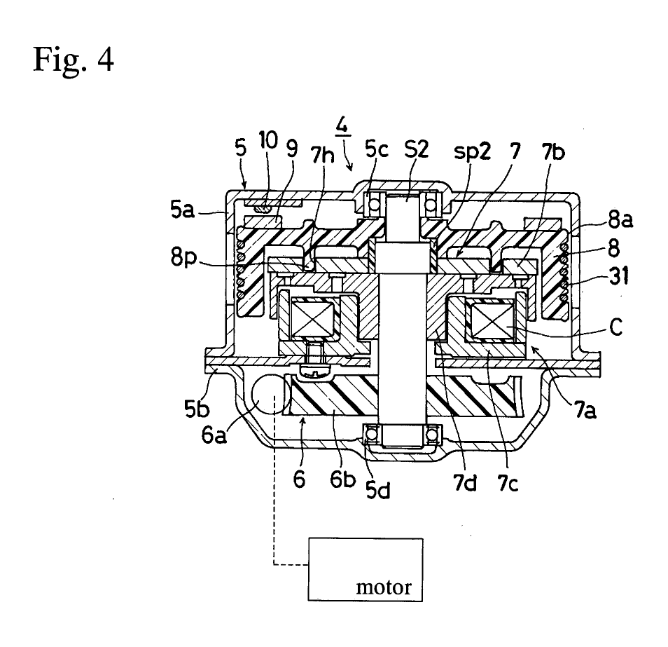

Referring to FIG. 4, a second embodiment is explained hereinafter. Common numbers are employed for common elements of the second embodiment in comparison with the first embodiment. A worm wheel gear 6b and a rotor 7d are fixed to a shaft S2 so that the gear 6b and the rotor 7d integrally rotate. A driving torque of a motor is transmitted to the rotor 7d through a reduction mechanism 6. An armature 7b is rotatably and movably, in axial direction, supported on the shaft S2 through the spacer sp2. The armature 7b is located between the rotor 7d and an output dram 8. A plurality of holes 7h is provided in the armature 7b so that a plurality of projections 8p of the output dram 8 is inserted into the holes 7h, respectively. The armature 7b and the output dram 8 are connected each other through the holes 7h and the projections 8p. The output dram 8 is formed cup-shaped in axial direction so that a clutch comprising the armature 7b, a core 7c and the rotor 7d is accommodated in the inner space of the output dram 8.

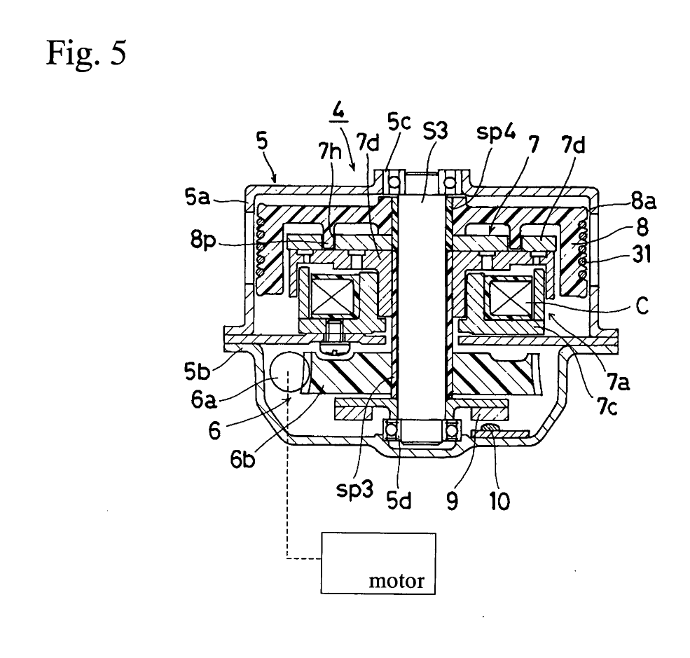

Referring to FIG. 5, a third embodiment is explained hereinafter. Common numbers are employed for common elements of the third embodiment in comparison with the first embodiment. A worm wheel gear 6b and a rotor 7d are fixed to a spacer sp3 so that the gear 6b and the rotor 7d are rotatably supported on a shaft S3 through the spacer sp3. The gear 6b and the rotor 7d integrally rotate each other. A driving torque of a motor is transmitted to the rotor 7d through a reduction mechanism 6. An armature 7b is rotatably and movably, in axial direction, supported on the shaft S3 through the spacer sp4. The armature 7b is located between the rotor 7d and an output dram 8. A plurality of holes 7h is provided in the armature 7b so that a plurality of projections 8p of the output dram 8 is inserted into the holes 7h, respectively. The armature 7b and the output dram 8 are connected each other through the holes 7h and the projections 8p. The output dram 8 is formed cup-shaped in axial direction so that a clutch comprising the armature 7b, a core 7c and the rotor 7d is accommodated in the inner space of the output dram 8.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A driving apparatus for a movable member of an automobile comprising:
a housing,
a dram for driving the movable member, the dram being rotatably supported on the housing, and
a clutch for selectively transmitting a driving torque to the dram,
wherein the clutch is accommodated in a space of the dram.

2. The driving apparatus according to the claim 1, wherein the clutch comprises an armature, a core, a coil wound around the core, a rotor facing to the armature and fixing the output dram, the rotor being integrally fixed to the shaft and the armature is rotatbly supported on the shaft.

3. The driving apparatus according to the claim 2, wherein the armature is rotatbly supported on the shaft through a spacer.

4. The driving apparatus according to the claim 2, further comprising an input member for providing the armature with the driving torque, wherein a plurality of holes are provided in the armature so that a plurality of projections of the input member is inserted into the holes, respectively.

5. The driving apparatus according to the claim 2, wherein the dram is formed in cylindrical shape so as to be fixed to the rotor.

6. The driving apparatus according to the claim 1, wherein the dram is formed in cup shape.

7. The driving apparatus according to the claim 2, wherein the dram is formed in cup shape, and a plurality of holes are provided in the armature so that a plurality of projections of the dram is inserted into the holes, respectively.
